(19) United States
(12) Patent Application Publication
(10) Pub. No.: US 2013/0317188 A1
(43) Pub. Date: Nov. 28, 2013

(54) CONTROLLED, IMINE BASE-INITIATED POLYMERIZATION

(71) Applicants: Friedrich Georg Schmidt, Haltern am See (DE); Stefan Spange, Orlamuende (DE); Ingmar Polenz, Goettingen (DE)

(72) Inventors: Friedrich Georg Schmidt, Haltern am See (DE); Stefan Spange, Orlamuende (DE); Ingmar Polenz, Goettingen (DE)

(73) Assignee: EVONIK DEGUSSA GmbH, Essen (DE)

(21) Appl. No.: 13/983,375

(22) PCT Filed: Mar. 6, 2012
(86) PCT No.: PCT/EP2012/053782

§ 371 Date: Aug. 2, 2013

(30) Foreign Application Priority Data
Apr. 11, 2011 (DE) 10 2011 007 102.4

(51) Int. Cl. C08F 2/00

(52) U.S. Cl. CPC C08F 2/00
USPC 526/205; 526/204; 526/217

(57) ABSTRACT

The present invention relates to an innovative polymerization technique for (meth)acrylates or styrenes, in which a special base with imine structure is added as a latent initiator, and the polymerization can be initiated without adding a coinitiator, at high temperatures. With this new and selectively employable technique it is also possible to produce high molecular weight poly(meth)acrylates having in some cases narrow molecular weight distribution. Furthermore, employing this new polymerization technique, a wide variety of different polymer architectures is available, such as block, star, or comb polymers.

### FIELD OF THE INVENTION

The present invention relates to an innovative polymerization technique for (meth)acrylates or styrenes, in which a special base with imine structure is added as a latent initiator, and the polymerization can be initiated without adding a coinitiator, at high temperatures. With this new and selectively employable technique it is also possible to produce high molecular weight poly(meth)acrylates having in some cases narrow molecular weight distribution. Furthermore, employing this new polymerization technique, a wide variety of different polymer architectures is available, such as block, star, or comb polymers.

The (meth)acrylate notation here denotes not only methacrylate, such as methyl methacrylate, ethyl methacrylate, etc., but also acrylate, such as methyl acrylate, ethyl acrylate, etc., for example, and also mixtures of both.

### PRIOR ART

For the polymerization of (meth)acrylates there are a series of known polymerization techniques. Free-radical polymerization in particular is of decisive significance industrially. In the form of bulk, solution, emulsion, or suspension polymerization, it is widely employed in the synthesis of poly(meth)acrylates for any of a very wide variety of different applications. These include molding compounds, Plexiglas, film-forming binders, additives, or components in adhesives or sealants, to recite only a few. Disadvantages of free-radical polymerization, however, are that no influence at all can be exerted over the polymer architecture, that their functionalization can be accomplished only without great specificity, and that the polymers are obtained with broad molecular weight distributions.

High molecular weight and/or narrow-range poly-(meth)acrylates, in contrast, are available by means of anionic polymerization. Disadvantages of that polymerization technique, on the other hand, are the high demands on the processing regime, in terms, for example, of moisture exclusion or temperature, and the impossibility of realizing functional groups on the polymer chain. Similar comments apply to the group transfer polymerization of methacrylates, which has hitherto acquired only very little significance.

Suitable living or controlled polymerization techniques, besides anionic polymerization, include modern techniques of controlled radical polymerization. Both the molecular weight and the molecular weight distribution can be regulated. As living polymerization, they also allow the selected construction of polymer architectures such as random copolymers or else block copolymer structures, for example.

One example is RAFT polymerization (reversible addition fragmentation chain transfer polymerization). The mechanism of RAFT polymerization is described in more detail in EP 0 910 587. Principal disadvantages of RAFT polymerization are the limited possibility for synthesis of short-chain poly(meth)acrylates or of hybrid systems, and the remanence of sulfur groups in the polymer.

The NMP technique (nitroxide mediated polymerization), in contrast, is of only very limited usefulness for the synthesis of poly(meth)acrylates. This method has great disadvantages in respect of diverse functional groups and the selective adjustment of the molecular weight.

The ATRP method (atom transfer radical polymerization) was developed in the 1990s significantly by Prof. Matyjaszewski (Matyjaszewski et al., J. Am. Chem. Soc., 1995, 117, p. 5614; WO 97/18247; Science, 1996, 272, p. 866). ATRP yields narrow-range polymers in the molar mass range of Mₙ=10 000-120 000 g/mol. A principal disadvantage is the use of transition metal catalysts, especially copper catalysts, whose removal from the product is very laborious and/or incomplete. Furthermore, acid groups disrupt the polymerization, and so such functionalities cannot be realized directly by means of ATRP.

Okamoto et al. (J. of Pol. Sci.: Polymer Chemistry, 12, 1974, p. 1135-1140) describe the initiation of an MMA polymerization using triethylamine and isocyanates. This system, however, leads to yields only of below 20%.

German patent application 102009055061.5 describes a technique for polymerizing (meth)acrylates with initiation using a mixture of bases having imine structure and isocyanates. That technique, however, operates only if both components are added at relatively low temperatures.

### Problem

A problem addressed by the present invention is that of providing a new polymerization technique for the polymerization of (meth)acrylates and/or styrenes that can be carried out with only one initiator component.

Another problem addressed by the present invention is that of providing a new initiator system for (meth)acrylates and/or styrenes that can be added latently to the monomer mixture and can be activated selectively by an increase in temperature.

A problem addressed more particularly is that of providing a polymerization technique which can be used to produce high molecular weight poly(meth)acrylates with optionally narrow molecular weight distributions, preferably in yields of more than 20%.

A further problem addressed, moreover, is that of providing a polymerization technique for (meth)-acrylates that can be deployed variably and diversely and that does not leave behind any disruptive initiator residues or catalyst residues such as transition metals in the polymer.

Further problems addressed, not explicitly stated, will become apparent from the overall context of the description, claims, and examples below.

### Solution

The problems addressed have been solved by a very surprisingly found, new initiation mechanism using as initiator an organic base which has a carbon-nitrogen double bond, at a temperature of at least 60° C., preferably at least 80° C., with which polymerization of vinylic monomers M can be initiated. Vinylic monomers M in this context are monomers which have a carbon-carbon double bond. Monomers M may also comprise a mixture of different, copolymerizable monomers. Generally speaking, such monomers may be polymerized radically and/or anionically. In this new method, the polymerization of monomers M is initiated through the presence of a strong base, preferably having an imine structure.

More particularly it has been found that, surprisingly at temperatures of at least 60° C., preferably at least 80° C., the polymerization can be initiated simply with an organic base as initiator, without the use of a cocatalyst.

The component B is preferably a tertiary organic base, more particularly an organic base which has a carbon-nitrogen double bond.

The bases of the invention have the general structural formula

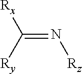

Here, R_{z} is a radical which is bonded to the nitrogen either via a carbon atom or via an oxygen atom. In the case of a carbon atom, the radical in question may be an alkyl radical or an aromatic group, which may also have further heteroatoms. In accordance with the invention, R_{z} is not hydrogen.

Rₓ and R_{y} are radicals which are attached to the carbon alternatively via a carbon, nitrogen, sulfur, or oxygen atom. In the case of a carbon atom, the radical in question may be an alkyl radical or an aromatic group, which may also have further heteroatoms. In accordance with the invention, Rₓ is not hydrogen. R_{y}, alternatively, may also be a hydrogen atom. Furthermore, the radicals Rₓ and R_{y} and/or the radicals Rₓ and R_{z} may in turn be joined to one another to form a ring. This ring may in turn have heteroatoms and/or double bonds.

In an alternative embodiment the organic base has the form

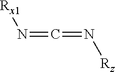

where the radical Rₓ₁ may be attached to the nitrogen via a carbon, sulfur, or oxygen atom.

Suitable more particularly for use in the initiation method of the invention are bases having the following functional groups: imines, oxazolines, isoxazolones, thiazolines, amidines, guanidines, carbodiimides, or imidazoles.

Imines are compounds which have an (Rₓ)(R_{y})C═N(R_{z}) group. The two groups on the carbon atom here, Rₓ and R_{y}, and the group on the nitrogen atom, R_{z}, are freely selectable, identical to or different from one another, and may also form one or more ring systems. It is important, however, that R_{z} and Rₓ are not hydrogen. Preferably, R_{z} is an alkyl radical or R_{z} forms a ring with one of the other two radicals, Rₓ or R_{y}. Examples of such imines are 2-methylpyrroline (1), N-benzylidenemethylamine (BMA, (2)), or N-4-methoxybenzylideneanaline (3).

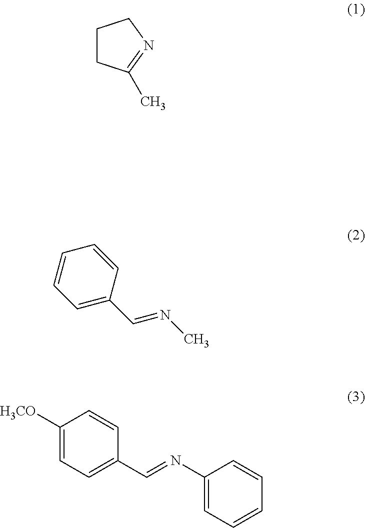

Oxazolines are compounds which have an (R_{y})O—C(Rₓ)═N(R_{z}) group. In the case of these compounds as well, the groups on the carbon atom, Rₓ, on the oxygen, R_{y}, and on the nitrogen atom, R_{z}, in accordance with the statements made in relation to the imines, are in each case freely selectable, identical to or different from one another, and may also form one or more ring systems. Examples of oxazolines are 2-ethyloxazoline (4), 2-phenyloxazoline (5), para-bis-(2,2′)oxazolinylbenzene (6), and (2,2′)bisoxazoline (7):

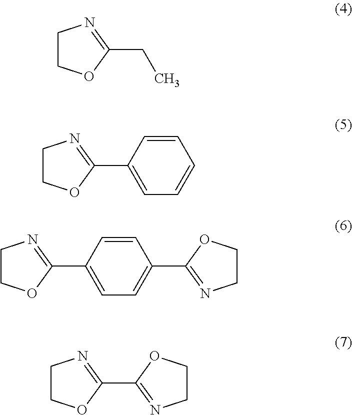

Isoxazolones are compounds having the structural element (8):

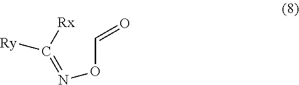

For the two groups on the carbon atom as well, Rₓ and R_{y}, in the isoxazolones, it is the case that in accordance with the statements made in relation to the imines, they are freely selectable and may be identical to or different from one another. It is also possible for them to form one or more ring systems. One example of such an isoxazolone is 3-phenyl-5-isoxazolone (9):

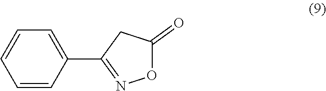 [SMILES: O=C1CC(c2ccccc2)=NO1]

Oxazoles are compounds which have an (R_{y})(Rₓ)C═N—O(R_{z}) group. With these compounds as well, the groups on the carbon atom, Rₓ and R_{y}, and also on the oxygen, R_{z}, in accordance with the statements made in relation to the imines, are in each case freely selectable, identical to or different from one another, and may also form one or more ring systems. One example of oxazoles is oxazole (10):

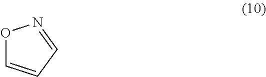

Thiazolines are compounds having the structural element (11) or (12):

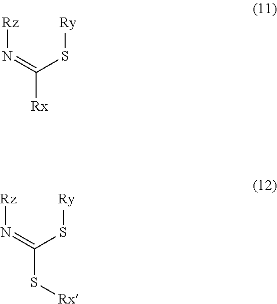

For the groups on the carbon atom, Rₓ, on the sulfur atom, R_{y}, on the second sulfur atom, R_{x′}, and on the nitrogen atom, R_{z}, it is the case that, in analogy to the statements made in relation to the imines, they are freely selectable and may be identical to or different from one another. It is also possible for them to form one or more ring systems. Examples of such thiazolines are 2-methylthiazoline (13) or 2-methylmercapto-thiazoline (14):

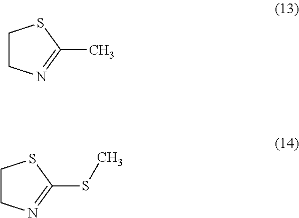

Amidines are compounds having the structural element (15); guanidines are compounds having the structural element (16):

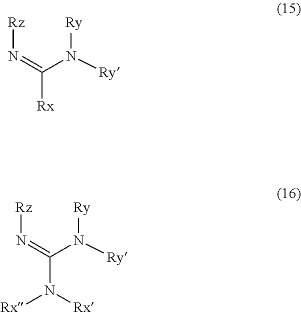

For the groups on the carbon atom, Rₓ, on the nitrogen atom, R_{z}, on the second nitrogen atom, R_{y} and R_{y′}, and on the third nitrogen atom, R_{x′} and R^{x″}, it is the case that, in analogy to the statements made in relation to the imines, they are freely selectable and may be identical to or different from one another. It is also possible for them to form one or more ring systems.

Examples of amidines are 1,8-diazabicyclo[5.4.0]undec-7-ene (DBU, (17)), 1,5-diazabicyclo[4.3.0]non-5-ene (DBN, (18)), or N-(3-triethoxysilylpropyl)-4,5-dihydro-imidazole (PDHI, (19)):

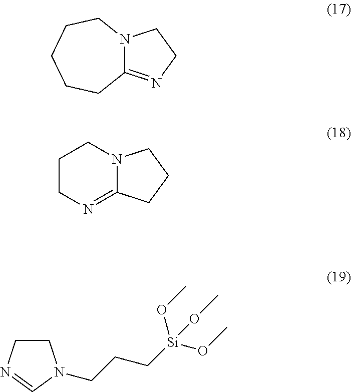

Examples of the guanidines are 7-methyl-1,5,7-triazabicyclo[4.4.0]dec-5-ene (MTBD, (20)) or N-tert-butyl-1,1,3,3-tetramethylguanidine (21):

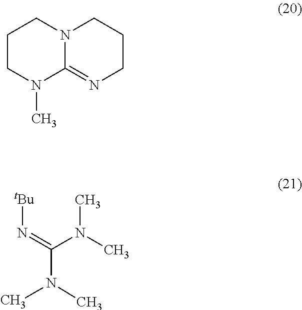

The group of the carbodiimides comprises compounds having the structural element (Rz)-N═C═N-(Rz′). For the groups on the nitrogen atoms, Rz and Rz′, it is the case that, in analogy to the statements made in relation to the imines, they are freely selectable and may be identical to or different from one another. It is also possible for them to form one or more ring systems. Examples of carbodiimides are diisopropyl-carbodiimide (22) or dicyclohexylcarbodiimide (23):

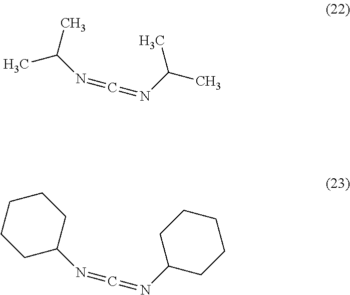

The carbodiimides may additionally be oligomeric compounds of the general formula (24). Similar compounds having an average degree of oligomerization x of 7 and having terminal polyether units are sold by the company Nisshinbo, for example, as stabilizers for polyurethane dispersions:

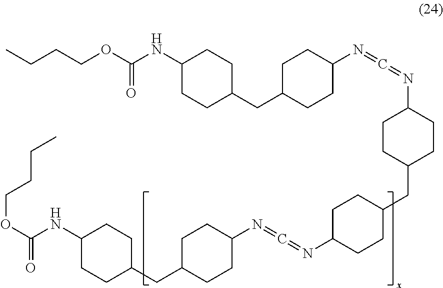

Further examples are imidazole (25) or 1-methyl-imidazole (26):

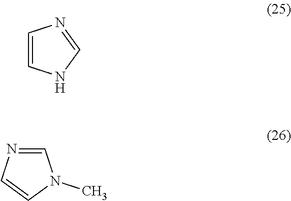

A further alternative as a base for the initiation is represented by 2-thio-substituted amidines. One example of such a substance is compound (27):

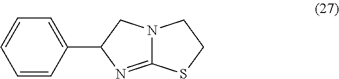 [SMILES: c1ccc(C2CN3CCSC3=N2)cc1]

The examples of the organic bases are not in any way such as to restrict the invention in any form whatsoever. Instead, they serve to illustrate the multiplicity of compounds which can be employed in accordance with the invention.

The method of the invention for initiating a polymerization is in principle independent of the polymerization method used. The method for initiation and the subsequent polymerization may be carried out, for example, in the form of a solution polymerization or bulk polymerization. The polymerization may be carried out in batch mode or continuously. Furthermore, the polymerization may be carried out under superatmospheric, atmospheric, or subatmospheric pressure.

One particular aspect of the present invention is that the polymers obtained from the method are produced in a very broad molecular weight range. In accordance with a GPC measurement against a polystyrene standard, these polymers may have a molecular weight of between 1000 and 10 000 000 g/mol, more particularly between 5000 and 5 000 000 g/mol, and very particularly between 10 000 and 2 000 000 g/mol.

The vinylic monomers M are monomers which have a double bond, more particularly monomers with double bonds which are polymerizable radically and/or anionically. More particularly the monomers are acrylates, methacrylates, styrene, styrene-derived monomers, α-olefins, or mixtures of these monomers.

The monomers may also comprise monomer mixtures, which are polymerized with statistical distribution to form copolymers. Where comonomers having very different copolymerization parameters are selected, it is also possible in this way to form gradient copolymers, or even block copolymers.

In general the monomers are selected from the group of the alkyl(meth)acrylates of straight-chain, branched, or cycloaliphatic alcohols having 1 to 40 C-atoms, such as, for example, methyl(meth)acrylate, ethyl(meth)acrylate, n-butyl(meth)acrylate, isobutyl(meth)acrylate, tert-butyl(meth)acrylate, pentyl(meth)acrylate, 2-ethylhexyl(meth)acrylate, stearyl(meth)acrylate, lauryl(meth)acrylate, cyclohexyl(meth)acrylate, isobornyl(meth)acrylate; aryl(meth)acrylates such as, for example, benzyl(meth)acrylate or phenyl(meth)acrylate, which in each case may be unsubstituted or have aryl radicals with 1-4-fold substitution; other aromatically substituted (meth)acrylates such as naphthyl(meth)acrylate, for example; mono(meth)acrylates of ethers, polyethylene glycols, polypropylene glycols, or mixtures thereof with 5-80 C-atoms, such as, for example, tetrahydrofurfuryl methacrylate, methoxy(m)ethoxyethyl methacrylate, 1-butoxypropyl methacrylate, cyclohexyl-oxymethyl methacrylate, benzyloxymethyl methacrylate, furfuryl methacrylate, 2-butoxyethyl methacrylate, 2-ethoxyethyl methacrylate, allyloxymethyl methacrylate, 1-ethoxybutyl methacrylate, 1-ethoxyethyl methacrylate, ethoxymethyl methacrylate, poly(ethylene glycol)methyl ether(meth)acrylate, and poly(propylene glycol)methyl ether(meth)acrylate, together.

The polymers prepared by the innovative method may find use in numerous fields of application. Without restricting the invention in any form whatsoever with these examples, such fields include acrylic glass, molding compounds, raw materials for other injection molding or extrusion applications, films, reflective films, packaging films, films for optical applications, laminates, laminate adhesives, foams, sealing foams, foamed materials for packaging, manmade fibers, composite materials, film-forming binders, coatings additives such as dispersing additives, or particles for scratchproof coatings, primers, binders for adhesives, hotmelt adhesives, pressure-sensitive adhesives, reactive adhesives or sealants, heat-sealing coating materials, packaging materials, dental materials, bone cement, contact lenses, spectacle lenses, other lenses, in industrial applications, for example, traffic markings, floor coatings, plastisols, underbody coatings and/or insulation for vehicles, insulating materials, materials for use in pharmaceuticals, drug delivery matrices, oil additives such as flow improvers, polymer additives such as impact modifiers, compatibilizers, or flow improvers, fiber spinning additives, particles in cosmetic applications, or as raw material for producing porous molds.

### EXAMPLES

The weight-average molecular weights of the polymers (with the exception of examples 11 and 13) were determined by means of GPC (gel permeation chromatography). The measurements were carried out using a PL-GPC 50 Plus from Polymer Laboratories Inc. at 40° C. in THF against a polystyrene standard. The measurement limit for M_{w} is approximately 400 000 g/mol.

The weight-average molecular weights of the polymers from examples 11 and 13 were determined by means of GPC (gel permeation chromatography) in a method based on DIN 55672-1. The measurements were carried out with a GPC from Polymer Laboratories Inc. with an oven temperature of 35° C., in THF, with a run time of 48 minutes, and against a polystyrene standard. The measurement limit for M_{w} is more than 15 000 000 g/mol.

The molar weight distribution (polymolecularity index, PDI) was calculated in each case as the ratio of the weight-average molecular weight to the number-average molecular weight.

The yields were determined by weighing the isolated polymer to constant weight after drying in a vacuum drying cabinet at 60° C. and 20 mbar.

### General Procedural Instructions for Examples 1-14

A 25 mL round-bottom flask is charged with 2.5 g (2.65 mL, 25 mmol) of methyl methacrylate (MMA) and in general 4.2 mmol of base (base used: see Table 1; amounts may differ), and this initial charge is stirred at an oil bath temperature of 100° C. After a reaction time t (see Table 1) with stirring, which is discontinued after a significant increase in viscosity, at 25° C., the mixture obtained is dissolved in 15 mL of chloroform and filtered. The solution is thereafter purified by precipitation, by dropwise addition to 300 mL of ice-cooled methanol. The PMMA is obtained as a white solid, and is isolated by filtration, washed three times with a total of 75 mL of methanol, and dried to constant mass in a vacuum drying cabinet at 60° C. and 50 mbar. For results, see Table 1.

### Example 15

Example 15 was carried out in analogy to the general procedural instructions, with methyl acrylate (MA) instead of methyl methacrylate (MMA) as monomer.

### Example 16

Example 16 was carried out in analogy to the general procedural instructions, with vinyl acetate (VA) instead of methyl methacrylate (MMA) as monomer.

TABLE 1

| | | MMA/ | t | | | Yield of |
|---|---|---|---|---|---|---|
| Example | Base | Base | [h] | M_{w} [g/mol] | PDI | PMMA [%] |
| 1 | (17) | 6/1 | 18 | 171 200 | 1.82 | 77 |
| 2 | (21) | 6/1 | 5 | 148 000 | 1.72 | 99 |
| 3 | (1) | 6/1 | 18 | 186 700 | 1.81 | 11 |
| 4 | (13) | 6/1 | 18 | 224 300 | 2.43 | 13 |
| 5 | (10) | 6/1 | 18 | 335 300 | 1.41 | 18 |
| 6 | (22) | 2/1 | 30 | 63 000 | 1.77 | 12 |
| 7 | (14) | 6/1 | 18 | 90 100 | 2.91 | 82 |
| 8 | (9) | 6/1 | 14 | 124 200 | 1.92 | 10 |
| 9 | (5) | 6/1 | 4 | 182 000 | 1.76 | 45 |
| 10 | (4) | 6/1 | 2.5 | 277 700 | 1.99 | 42 |
| 11 | (6) | 6/1 | 4 | 1 569 000 | 1.98 | 5 |
| 12 | (7) | 6/1 | 4 | 340 700 | 1.59 | 4 |
| 13 | (24) | 6/1 | 3 | 903 400 | 2.05 | 36 |
| 14 | (5) | 4/1 | 3 | 181 400 | 1.97 | 34 |
| 15 | (5) | 6 (MA)/1 | 3 | 146 100 | 1.65 | 44 (PMA) |
| 16 | (5) | 6 (VA)/1 | 48 | >1000 | n.d. | 9 (PVA) |

### Comparative Example 1

In an experiment carried out in analogy to the inventive examples (MMA/base ratio: 6/1), the base 1,1,3,3-tetramethylguanidine (25), used noninventively, leads to no polymerization.

### Comparative Examples 2-7

Experiments 1 to 5 repeated at 50° C. lead to no polymerization.

1. A method, comprising:
initiating a polymerization, of a vinylic monomer or a mixture of different, copolymerizable monomers with an organic base at a temperature of at least 60° C.,
wherein the organic base comprises a carbon-nitrogen double bond.

2. The method of claim 1, wherein the organic base is a compound of formula 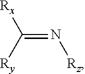
wherein
R_{z} is a radical bonded to nitrogen of the carbon-nitrogen double bond via carbon or oxygen,
Rₓ is a radical bonded to carbon of the carbon-nitrogen double bond via carbon, nitrogen, or sulfur, and
R_{y} is a hydrogen atom or a radical bonded to the carbon of the carbon-nitrogen double bond via carbon, nitrogen, or sulfur.

3. The method of claim 2, wherein
radicals Rₓ and R_{y} form a ring,
radicals Rₓ and R_{z} form a ring, or
radicals Rₓ and R_{y} and radicals Rₓ and R_{z} both form a ring.

4. The method of claim 2, wherein radical Rₓ is bonded to the carbon via an oxygen atom.

5. The method of claim 1, wherein the organic base is a compound of formula 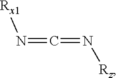
wherein
R_{z} is a radical bonded to a nitrogen of the carbon-nitrogen double bond via carbon or oxygen, and
Rₓ₁ is a radical bonded to a nitrogen via carbon, sulfur, or oxygen.

6. The method of claim 2, wherein the organic base is an imine.

7. The method of claim 4, wherein the organic base is an oxazoline or an oxazole.

8. The method of claim 2, wherein the organic base is an isoxazolone.

9. The method of claim 2, wherein the organic base is a thiazoline.

10. The method of claim 2, wherein the organic base is an amidine or a guanidine.

11. The method of claim 5, wherein the organic base is a carbodiimide.

12. The method of claim 1, wherein the vinylic monomer is an acrylate, a methacrylate, styrene, a styrene-derived monomer, an α-olefin, or any mixture thereof.

13. (canceled)
